(19) United States
(12) Patent Application Publication
(10) Pub. No.: US 2016/0201284 A1
(43) Pub. Date: Jul. 14, 2016

(54) Drainage Pipe Apparatus and System Thereof

(71) Applicant: MING-CHUN HU, New Taipei (TW)

(72) Inventor: CHEN-ZHI GU, Chengdu (CN)

(73) Assignee: MING-CHUN HU, New Taipei (TW)

(21) Appl. No.: 14/995,173

(22) Filed: Jan. 13, 2016

(30) Foreign Application Priority Data
Jan. 14, 2015 (CN) 201510017891.6

(51) Int. Cl. E02B 11/00; F16L 21/00

(52) U.S. Cl. CPC E02B 11/005; E02B 11/00; F16L 21/00

(57) ABSTRACT

The present invention discloses a drainage system and drainage pipes thereof. It fulfills the present request for a full coverage of the “capillary drainage belt/board” on a drainage pipe. The present disclosure provides a pipe body, with one or more mounting slot extending the entire length of said pipe body for an installation of the capillary drainage belt/boards. With more than one full-length mounting slot, the slots may be spaced from each other in equal intervals. The present disclosure also provides a fixation mechanism at the mounting slot on the pipe body for securing the capillary drainage belt/board and reinforcing the pipe body strength. The present invention may be manufactured in batch or from a factory assembly line, which lowers construction and labor costs, increases efficiency, increases slotting accuracy, shortens construction time and avoids onsite slotting. Meanwhile, with the fixation mechanism, the “capillary drainage belt/board” are in closer and more secure contact with the pipe body, thereby prevent the “capillary drainage belt/board” from slipping or pulling out of the mounting slots.

### CROSS REFERENCE TO RELATED APPLICATIONS

This non-provisional application claims priority under 35 U.S.C. §119(a) on Patent Application Serial No. 201510017891.6 filed in China on Jan. 14, 2015, the entire contents of which are hereby incorporated by reference.

### BACKGROUND OF THE INVENTION

1. Field of the Invention

The present invention relates generally to an installation of a “capillary drainage belt/board.” In particular, to a draining system and the drainage pipes thereof.

2. Description of the Related Art

It is known from the prior art that the drainage product, “capillary drainage belt/board/pipe,” is widely used in large-scale waterproofing and draining civil engineering projects (Chinese Pat. No. ZL97115515.1 titled Water draining method, and Chinese Pat. No. ZL99126199.2 titled Water draining method and drainage pipe thereof). The anti-clogging feature and the “capillary or siphoning” feature of the product allow suction of water within the soil into a number of capillary grooves. Due to a height level difference created by the pipeline installation, water automatically flows through the vertical capillary grooves into the horizontal or vertical drain pipes for discharge. Consequently, such installation accomplishes both the collection and drainage of water, and the “capillary drainage belt/board/pipe” needs to associate with water-collecting pipes in order to form a water collecting and draining system. Such system allows water to collect, transport and drain.

Onsite installation of the drainage belt/board (Chinese Pat. No. ZL97115515.1) mainly utilizes standard circular drainage pipes as shown in FIG. 1, such as PVC, PE and PPR circular drainage pipes. The installation steps for the existing drainage belts/boards (Chinese Pat. No. ZL97115515.1) are as the following.

Step 1, prepare a mounting slot on the draining pipe for the “capillary drainage belt/board” installation. In particular, the mounting slots are positioned vertically. The thickness and width of the mounting slots are the same as that of the “capillary drainage belt/board,” which minimizes any gap between the “capillary drainage belt/board” and the slot. Such design further prevents fine soil particles from entering the drainage pipe, which may result in drainage failure and clogging. Existing mounting slot positioning on a drainage pipe are shown in FIGS. 2 and 3.

Step 2, installation of the “capillary drainage belt/board” maybe either perpendicular, slanted or leveled with the mounting slots.

Step 3, silicon gel or waterproofing transparent tape are used to seal the gap between the “capillary drainage belt/board” and the mounting slot, which prevents fine soil particles from entering the pipes. FIGS. 4 and 5 are representations after the installation.

Step 4, rope binding for fixation prevents the “capillary drainage belt/board” from slipping or pulling out of the mounting slot. The belt/board may be dislodged because of the pressure from large machinery, or other indefinite causes during the engineering process. Ropes or binding means should be used to fixate the “capillary drainage belt/board” onto the drainage pipes by using predrilled holes.

The abovementioned installation procedure of the “capillary drainage belt/board” have the following inherent flaws after years of usage in waterproofing and drainage engineering works.

First, due to numerous uncertainties from a waterproofing and drainage engineering work, system installation of the “capillary drainage belt/board” usually depends on the water flow condition. Onsite water flow condition determines the layout spacing, and adjustments of the spacing may be needed after the design process in order to accommodate the actual landscape and water flow condition. Thus, the spacing between the mounting slots on the drainage pipes cannot be precisely made in a manufacturing factory, and are normally made onsite by manual slotting machine. Since manual slotting technique lacks precision, the resulting mounting slots may not be smooth and even, which leaves large gaps between the mounting slot and the “capillary drainage belt/board” after installation. If sealing from the silicon gel or waterproofing tape is less than optimal, then fine particles may easily leak into the pipes and cause deposits and clogging. Moreover, if the mounting slot size is smaller than the “capillary drainage belt/board,” then the “capillary drainage belt/board” will fail to insert into the mounting slot. Thus, the conventional procedure for installation requires significant amount of time and higher labor costs.

Second, due to construction backfill, pouring or other uncertainties from the large machineries on a construction site, the “capillary drainage belt/board” may slip or get pulled out from the mounting slot. This will lead to repetitive manual installation and lowers efficiency. Or, if the defect remains undetected, the defective area will fail to collect and transport water, and large amount of fine particles will accumulate and result in system clogging and repetitive effort.

Third, since there are several mounting slots along the drainage pipe, the compressive and tensile strengths of the pipe may be greatly compromised. Under the pressure from soil, the pipes may easily crack or break, leading to drainage system failure.

And last, onsite slotting of the mounting slots and sealing of the gaps between the mounting slot and the “capillary drainage belt/board” are time-consuming, inefficient, and increase labor and construction costs.

The conventional installation procedure makes close spacing between the mounting slots difficult because close spacing may compromise the overall strength of the pipe. Thus, spacing between each “capillary drainage belt/board” depends on the strength of the pipe, and smaller installation area of the capillary drainage belt/board may limit the draining capacity and extend the draining time.

Waterproofing and drainage works of current major constructions, such as road, tunnel, retaining wall and revetment constructions, require extensive amount of water drainage in a short amount of time. As a result, a high number of mounting slots are needed. However, the drainage pipe may not withstand pressure and pulling forces from the construction, and the “capillary drainage belt/boards” may not be stable on the pipes. If a high number of the “capillary drainage belt/boards” are needed, and no spacing between each mounting slot is preferred, then the conventional installation procedure may not be used. Instead, the drainage pipe will need to have a mounting slot extending along the entire longitudinal length of the pipe. Nevertheless, the following problems will then arise: (1) the drainage pipe does not meet the strength requirement; (2) the “capillary drainage belt/boards” cannot fully integrate with the drainage pipe; the product has limited application because the mounting slots cannot fully cover the entire length of the pipe, such as shown in FIGS. 6 and 7; (3) drainage pipes fail to connect with each other because there is no spacing between each “capillary drainage belt/board;” (4) the standard accessories, such as the pipe cap, cannot be installed for closure because there is no spacing between each “capillary drainage belt/board.”

As FIG. 8 shows, regarding the method of drainage and the use of the drainage pipe (ZL99126199.2), “capillary drainage pipe” has a coupling connector that introduces water collected from the surface into a inner pipe. Besides connecting the pipes, the connector also introduces the surface water into the inner pipe for discharge. Thus, with more connectors tightly spaced together, the surface water can be introduced into the inner pipe faster and in a larger volume. However, during the construction process, a larger number of connector means higher labor costs, higher installation fee, more difficult leveling work and weaker pipe tensile strength. At the same time, since the “capillary drainage belt” coats the outer layer of the inner pipe in parallel, the upper part of the pipe may develop clogging due to soil gravity. Since standard layout cannot create a siphoning effect, it loses two important advantages of the utility model, which are “separation of water and soil from gravity” and “drainage efficiency from the siphoning effect.”

### SUMMARY OF THE INVENTION

The present invention general relates to a drainage system and drainage pipes thereof. The invention having a drainage pipe comprising a pipe body with a mounting slot for an installation of a capillary drainage belt or a capillary drainage board, and a fixation mechanism at the mounting slot on the pipe body for securing the capillary drainage belt or the capillary drainage board.

Additionally, a drainage system is provided, wherein the drainage pipe of the system comprises a pipe body having a mounting slot for an installation of a capillary drainage belt or a capillary drainage board, and a fixation mechanism at the mounting slot on the pipe body for securing the capillary drainage belt or the capillary drainage board. A pipe cap may be present to connect to a terminal end of the drainage pipe for sealing the terminal end, wherein the pipe cap has a sealed end and an open end. Moreover, at least one slot gap may be present at the open end of the pipe cap for securing a plurality of a clamping piece.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The objects and features of the invention can be better understood with reference to the drawings described below and the claims. The drawings are not necessarily to scale. Emphasis is instead generally placed upon illustrating the general principles of the present invention. In these drawings, like numerals are used to indicate like parts throughout the various views.

FIG. 1 is a schematic representation of a conventional drainage pipe.

FIG. 2 is a first schematic representation of a conventional drainage pipe after installation of mounting slots.

FIG. 3 is a second schematic representation of a conventional drainage pipe after installation of mounting slots.

FIG. 4 is a first schematic representation of a conventional drainage pipe after installation of capillary drainage belt/boards.

FIG. 5 is a second schematic representation of a conventional drainage pipe after installation of capillary drainage belt/boards.

FIG. 6 is a third schematic representation of a conventional drainage pipe after full-length installation of the capillary drainage belt/board.

FIG. 7 is a cross-sectional view of the embodiment illustrated in FIG. 6.

FIG. 8 is a schematic representation of a conventional capillary drainage pipe.

FIG. 9 is a first schematic representation of the implementation of embodiment 1 of the present invention.

FIG. 10 is a second schematic representation of the implementation of embodiment 1 of the present invention.

FIG. 11 is a third schematic representation of the implementation of embodiment 1 of the present invention.

FIG. 12 is a fourth schematic representation of the implementation of embodiment 1 of the present invention.

FIG. 13 is a fifth schematic representation of the implementation of embodiment 1 of the present invention.

FIG. 14 is a sixth schematic representation of the implementation of embodiment 1 of the present invention.

FIG. 15 is a schematic representation of the removable clamping pieces of the present invention.

FIG. 16 is a schematic representation of the implementation of embodiment 2 of the present invention.

FIG. 17 is a schematic representation of a gap sealing strip of embodiment 3 of the present invention.

FIG. 18 is a schematic representation of a fixation device of embodiment 4 of the present invention.

FIG. 19 is a first schematic representation of a pipe cap of embodiment 5 of the present invention.

FIG. 20 is a second schematic representation of a pipe cap of embodiment 5 of the present invention.

FIG. 21 is a first schematic representation of a coupling connector of embodiment 5 of the present invention.

FIG. 22 is a second schematic representation of a coupling connector of embodiment 5 of the present invention.

FIG. 23 is a third schematic representation of a coupling connector of embodiment 5 of the present invention.

FIG. 24 is a first schematic representation of the implementation of embodiment 5 of the present invention.

FIG. 25 is a second schematic representation of the implementation of embodiment 5 of the present invention.

FIG. 26 is a third schematic representation of the implementation of embodiment 5 of the present invention.

FIG. 27 is a fourth schematic representation of the implementation of embodiment 5 of the present invention.

FIG. 28 is a schematic representation of the implementation of embodiment 6 of the present invention.

FIG. 29 is a schematic representation of the clamping pieces of embodiment 6 of the present invention.

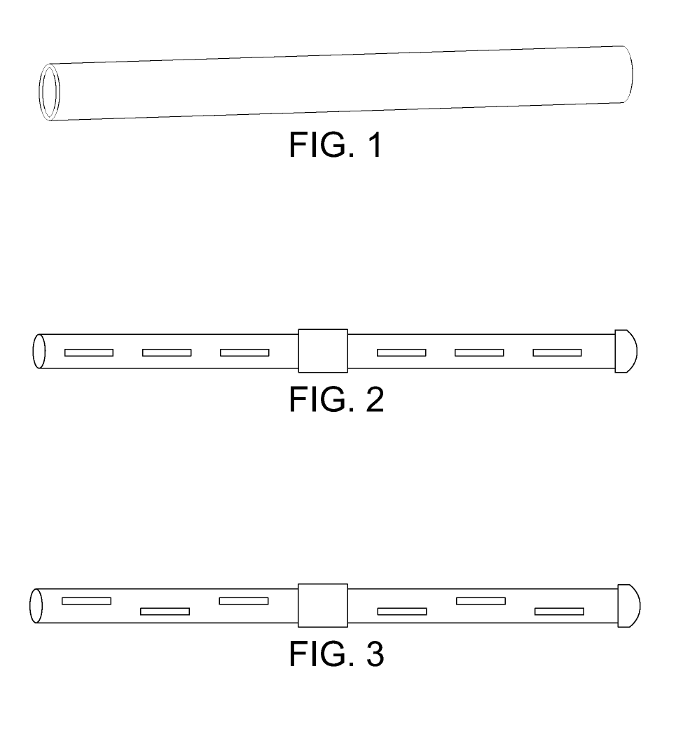

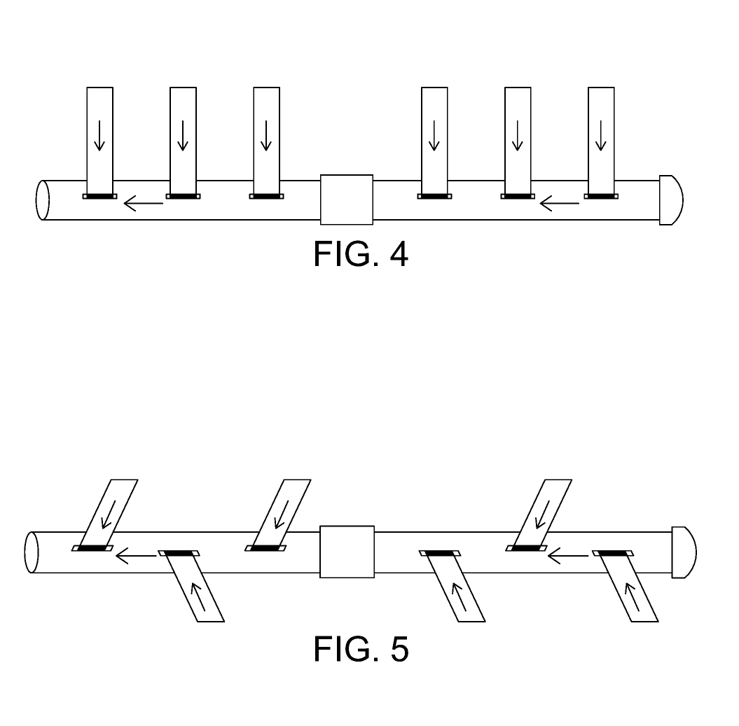

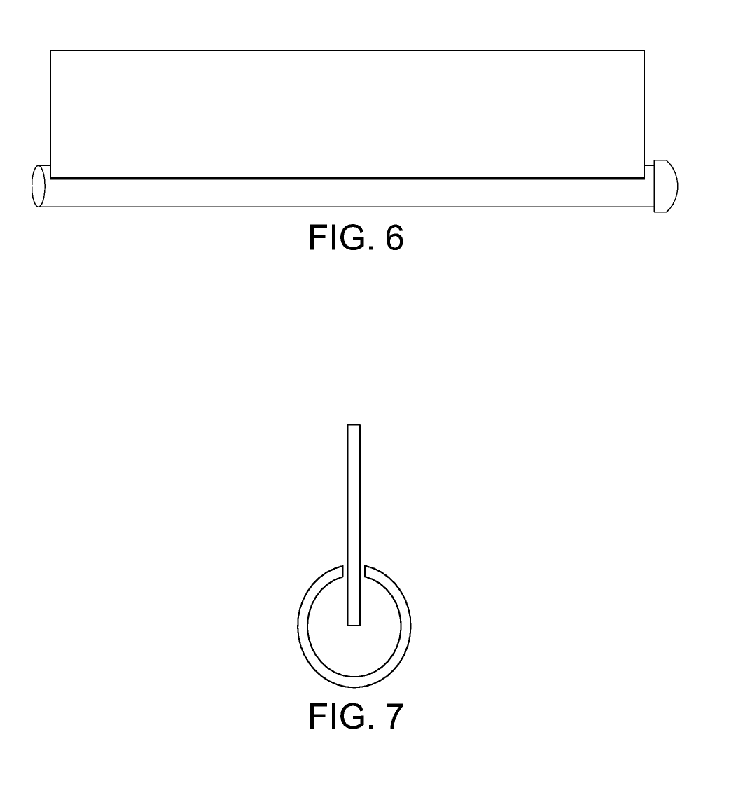

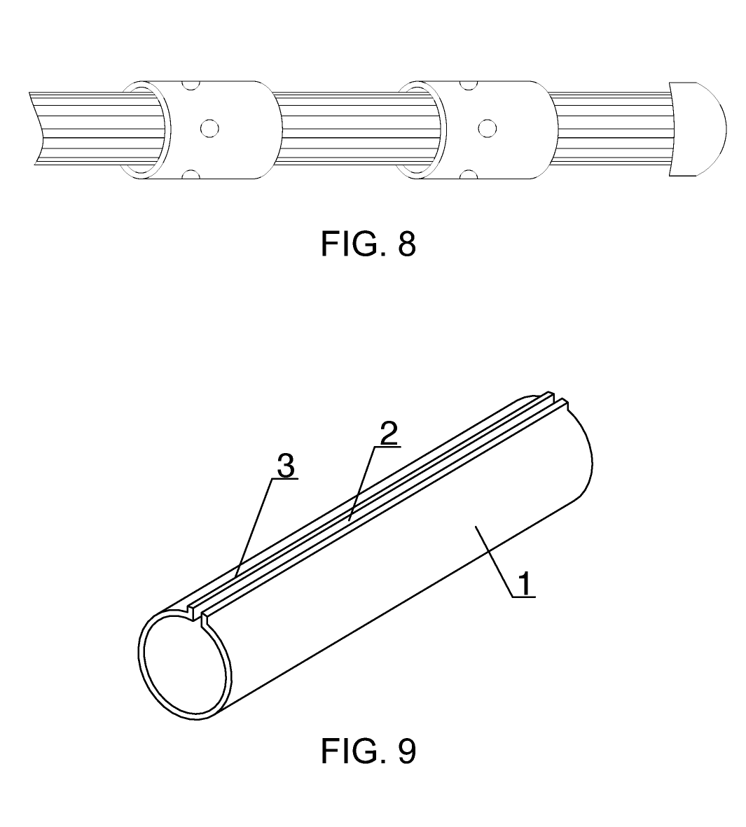

Wherein, the drawing reference numbers correspond to each part as the following: 1—pipe body, 2—mounting slot, 3—clamping piece, 4—gap sealing strip, 5—fixation device, 6—reinforcing bar, 7—threaded mounting hole, 8—pipe cap, 9—slot gap, 10—connecor, 11—opening, 12—separation ring, 13—capillary drain belt/board and 14—groove.

### DETAILED DESCRIPTION OF THE EMBODIMENTS

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

### Embodiment 1

A type of drainage pipe comprises pipe body 1. The pipe body is provided with one or more mounting slot 2 for the installation of capillary drainage belt/board, and is provided with a fixation mechanism on the pipe body at the opening of the mounting slot for fixating the capillary drainage belt/board. The fixation mechanism comprising two clamping pieces 3 in connection with the pipe body. The mounting slot is provided with one clamping piece on each side. Moreover, the fixation mechanism may also comprise threaded mounting holes for fixating the capillary drainage belt/board onto the pipe body, or a medium inside the mounting slot with a certain strength and elasticity. The medium may exist in two, and the two mediums are provided with a gap for the insertion of the capillary drainage belt/board.

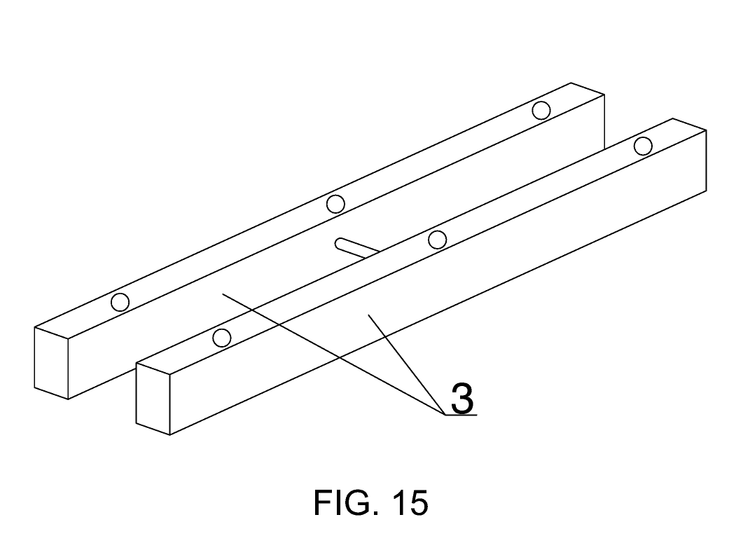

As a preferred embodiment, the pipe body may be provided with clamping pieces, such as shown in FIGS. 9, 10 and 11. The clamping pieces are located on the external wall of the pipe body, and each of the two clamping pieces is located on one side of the mounting slot. The clamping pieces and pipe body may be formed from injection moulding or integrally formed from synthetic resin or other materials, and may be removable. As shown in FIG. 15, the removable clamping pieces may be provided with threaded mounting holes, and screws may be used to secure the clamping pieces onto the pipe body (either secured on the outer wall or inner wall of the pipe body). When the clamping pieces are removable, in order to stabilize the clamping pieces during the installation process, more than one connector maybe used between the two clamping pieces.

After installation of the capillary drainage belt/board into the mounting slot, not only the pipe body (meaning the opening of the mounting slot) gives a stabilizing effect from its pressing force, the two clamping pieces may also provide pressing forces against the capillary drainage belt/board for stabilization. With stabilizing effects from both the pipe body and the clamping pieces, the connection between “capillary drainage belt/board” and the drainage pipe is thereby tighter and more secure. Such design prevents the “capillary drainage belt/boards” from slipping or pulling out of the mounting slots.

Furthermore, the design effectively prevents silt from entering the pipe body through any gap opening, which may cause clogging and lowers draining efficiency. With the implementation of the present embodiment, the draining efficiency is greatly increased.

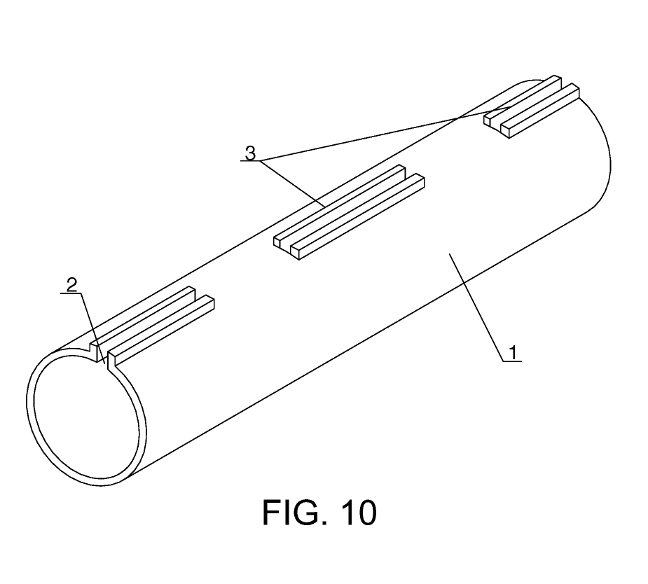

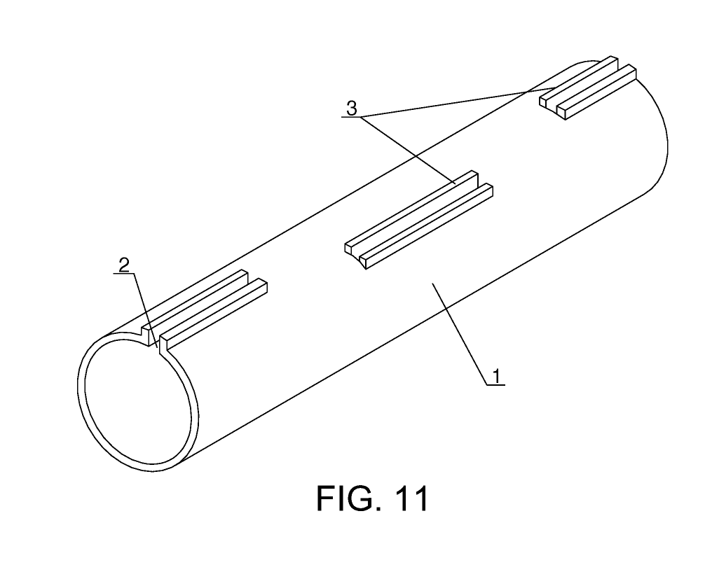

Nevertheless, the present embodiment offers three forms of mounting slot opening. FIG. 9 illustrates having only one mounting slot, wherein the mounting slot extends from one end to the other end of the pipe body. The length of such an opening is the same as the length of the pipe body, and is the preferred form of mounting slot opening. FIG. 10 illustrates multiple mounting slot openings in a straight line along the longitudinal length of the pipe body. FIG. 11 illustrates multiple mounting slot openings along the longitudinal length of the pipe body, but with staggered intervals in-between. Note that the clamping pieces of the present invention not only secure the capillary drainage belt/board, but also strengthen the pipe body.

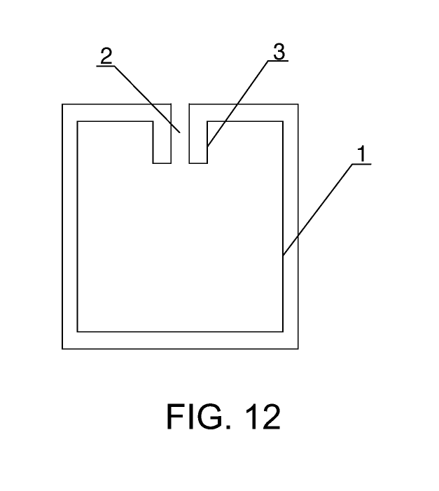

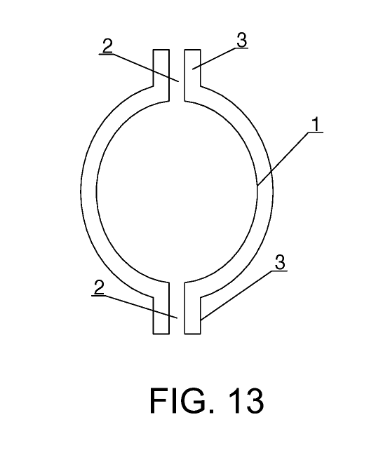

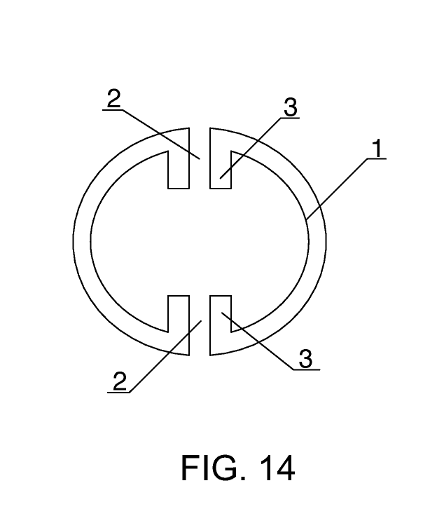

FIGS. 12, 13 and 14 illustrate various cross-sectional views of the pipe body of the present invention. The mounting slot opening in all three illustrations is a full-length opening along the entire longitudinal length of the pipe body (referred to as full-length mounting slot hereunder). When two or more full-length mounting slots are used, a guiding device needs to be installed between the two mounting slots to secure against the pipe body. As a preferred embodiment, only one or two full-length mounting slots are utilized. Moreover, depending on the actual situation, not only a full-length mounting slot may present on the pipe body, multiple shorter mounting slots may also present on the pipe body along with a full-length mounting slot. According to the illustrations, the clamping pieces may be installed on either or both the outer and inner walls of the pipe body. Also, the cross-sectional shape of the pipe body may be circular, square, oval or in any other shape.

In addition, depending on the actual situation, when the width of the capillary drainage belt/board is shorter than the diameter of the pipe body, the belt/board may be installed horizontally along the altitudinal direction of the pipe body. Consequently, the capillary drainage belt/board may be installed along both the longitudinal and altitudinal directions of the pipe body. Nevertheless, longitudinal positioning is a preferred embodiment of the present invention.

### Embodiment 2

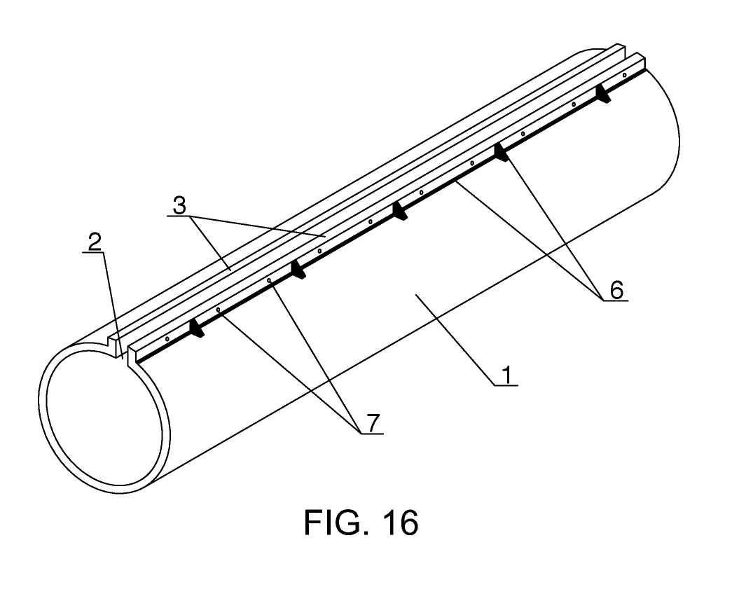

As shown in FIG. 16, the differences between the present second embodiment and embodiment 1 is an addition of a reinforcing bar 6 at the mounting slot for pipe body strengthening, and an addition of a threaded mounting hole 7 on the clamping piece or pipe body for stabilization. The reinforcing bar is to reinforce the strength around the mounting slot, and to prevent malfunctioning of the pipe body from installation. Moreover, in order to secure the attachment of the capillary drainage belt/board onto the pipe body, threaded mounting holes are provided on the clamping piece or the pipe body. Such design prevents the capillary drainage belt/boards from slipping or pulling out of the mounting slots. Note that the reinforcing bars may be placed either or both longitudinally and attitudinally between the clamping pieces and the pipe body outer wall. The reinforcing bars may also be placed only on the pipe body or on the clamping pieces. The cross-sectional shape of the reinforcing bars may be triangular, rectangle or in any other shape. Said threaded mounting hole may be provided on either or both the clamping pieces and the pipe body.

### Embodiment 3

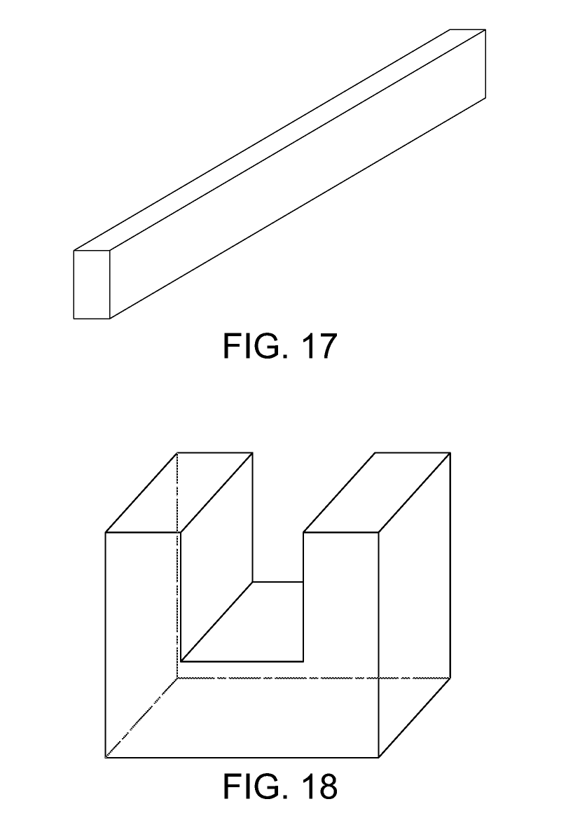

The difference between the present third embodiment and embodiment 1 is an addition of a gap sealing strip 4 between the two clamping pieces. FIG. 17 a schematic representation of a gap sealing strip. Nevertheless, the shape of the gap sealing strip may be rectangular, trapezoidal or square. Its function is to seal off any gap between the capillary drainage belt/board and the mounting slot when the width of the belt/board is shorter than that of the mounting slot. The gap sealing strip may be snapped in place to completely seal the gap, and prevent any leakage of silt into the pipe body. Meanwhile, it may help to balance the two clamping pieces, thereby facilitate normal drainage.

### Embodiment 4

As shown in FIG. 18, the difference between the present fourth embodiment and embodiment 1 is an addition of fixation device 5 on said clamping piece for stabilization between the capillary drainage belt/board and the clamping pieces. The fixation device may be in a “U” shape, and functions in securing the two clamping pieces together, thereby stabilizing the capillary drainage belt/board. Note that FIG. 18 is merely an illustration of the fixation device, and the fixation device may also be in a circular “U” shape or any other shape, as long as it can tightly secure the two clamping pieces together, and prevent any gap between the clamping piece and the capillary drainage belt/board.

Note that the abovementioned embodiments do not limit the applications of the drainage pipe of the present invention. The parts described in the embodiments may be in different combinations to yield other technical solutions. For example, installation on the pipe body may comprise clamping pieces, reinforcing bars and gap sealing strips, and installation on the pipe body may also comprise clamping pieces, threaded mounting holes and gap sealing strips. Furthermore, when the drainage pipe connects with a pipe cap or connector during installation, fixation devices or threaded mounting holes may be omitted. The pipe cap or connector may secure the drainage pipe, thereby stabilizing the capillary drainage belt/board. If further stabilization is preferred, fixation devices or threaded mounting holes may be added (using screws or ropes).

### Embodiment 5

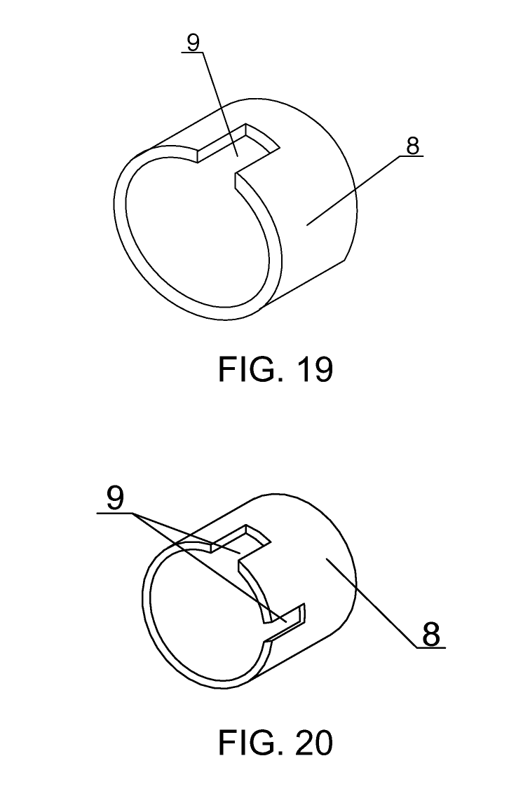

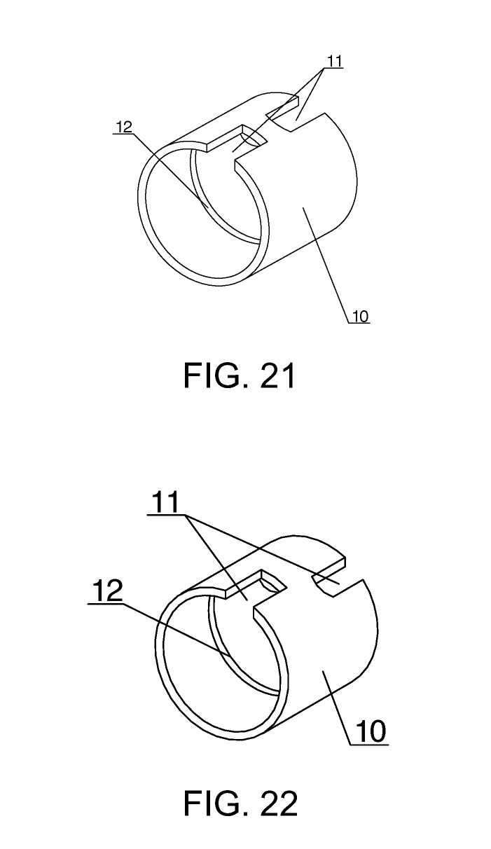

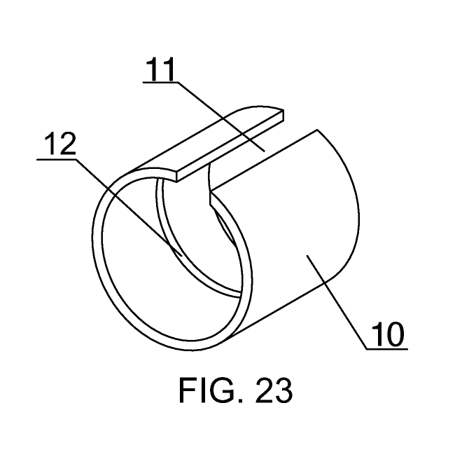

A drainage system may include said drainage pipe, and also include a pipe cap 8, which connects to one end of the drainage pipe and is used for sealing the drainage pipe. As shown in FIGS. 19 and 20, said pipe cap has two ends; one sealed end and one opened end. On the opened end and parallel to the end opening is one or more slot gap 9. Slot gap 9 may be used to secure the clamping pieces. When multiple drainage pipes are combined, the present invention may include a connector 10 connecting two adjacent drainage pipes. As shown in FIGS. 21, 22 and 23, said connector may be a hollow cylindrical structure. The two ends of said connector may be provided with one or more opening 11 for securing a clamping piece. The connector may also be a hollow columnar structure, with an opening 11 extending along the entire longitudinal length of the connector for securing the clamping pieces. The inner wall of said connector may be provided with projections of annular separation ring 12. Depending on the actual situation, the separation rings may be omitted. The pipe cap and connector may be manufactured using any type of material. As a preferred embodiment, when a connector from FIG. 23 is used, the connector may be made from a high strength and high elastic material. The connector may also bear screw holes, and screws may be used to further fixate the clamping pieces.

Having corresponding slot gaps on said pipe cap and connector is to facilitate compatibility with the fixation mechanism (clamping pieces) on the drainage pipe. The other function of the slot gaps is to secure the clamping pieces onto the drainage pipe end, and further secure the capillary drainage belt/board. If the clamping pieces are not used as fixation mechanisms on the drainage pipe, then the slot gaps may be omitted from the pipe cap and connector. Furthermore, if the mounting slot is not a full-length mounting slot, and the two ends of the drainage pipe do not provide mounting slots, then the slot gaps may be omitted from the pipe cap and connector as well.

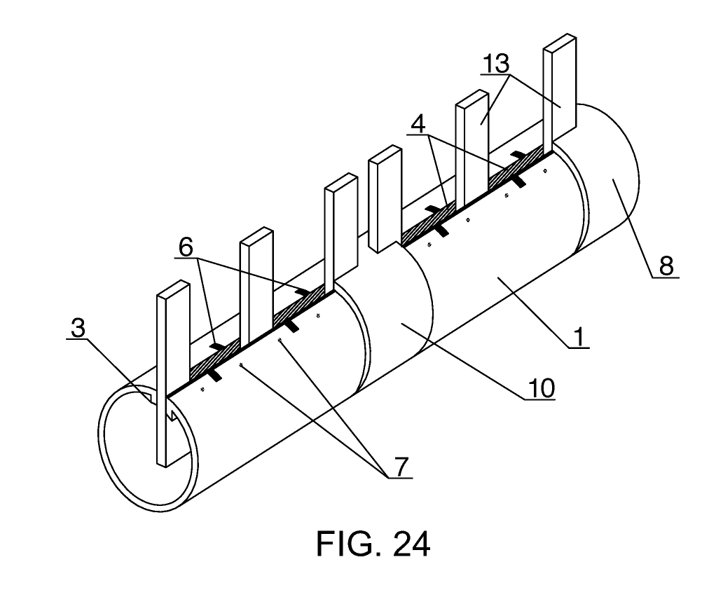

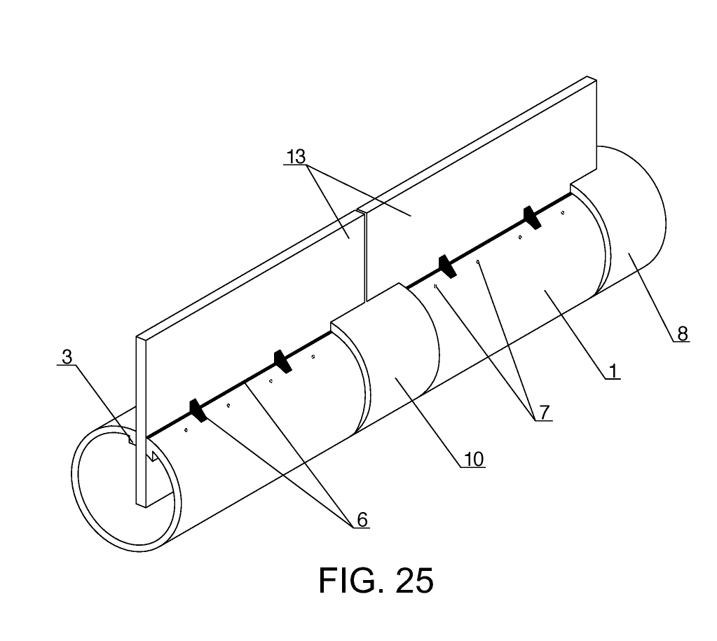

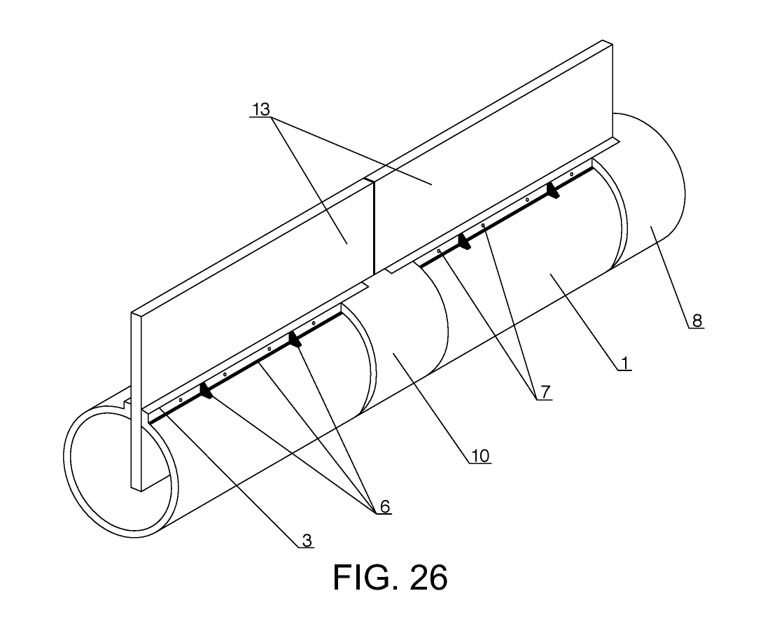

FIG. 24 is a first schematic representation of the implementation of the present embodiment. The cross-sectional structure of said representation is in a “ [symbol] ” shape. The clamping pieces are on the inner wall of the drainage pipe, and the mounting slot is one full-length mounting slot extending to both ends of the drainage pipe. The capillary drainage belt/board are installed into the mounting slot in intervals with gap sealing strips inserted between each interval to prevent silt leakage. In order to reinforce the strength of the drainage pipe, longitudinal and altitudinal reinforcing bars are added near the mounting slot. The cross-sectional shape of the reinforcing bar may be triangular, rectangular or in any other shape. Depending on the actual situation, reinforcing bar may also be added between the inner wall of the drainage pipe and the clamping piece. In order to secure the capillary drainage belt/board, the drainage pipe is further provided with multiple threaded mounting holes. Screws may be used for securing the capillary drainage belt/board, and thereby prevent the capillary drainage belt/board from slipping out of the mounting slot. As a result, applications of the present embodiment are simple, and help to eliminate all the flaws in a conventional drainage system.

FIG. 25 is a second schematic representation of the implementation of the present embodiment. The difference between the present embodiment and embodiment 1 is a full coverage of the capillary drainage belt/board in the present embodiment. In other words, the capillary drainage belt/boards are not installed in intervals in the mounting slot. If the length of the capillary drainage belt/board is the same as the length of a full-length mounting slot, then only one capillary drainage belt/board is installed. If the length of the capillary drainage belt/board is shorter than that of a full-length mounting slot, then multiple capillary drainage belts/boards may be connected or welded together. In addition, the connector used in the present embodiment is a fully opened connector (a slot gap is opened along the entire length of the connector). No gap sealing strip is needed for the present embodiment.

FIG. 26 is a third schematic representation of the implementation of the present embodiment. The difference between the present representation and first representation is the cross-sectional shape of the drainage pipe. Drainage pipe from the second representation has clamping piece on the inner wall of the pipe body, wherein the present representation has clamping piece on the outer wall of the pipe body. Moreover, the present representation has longitudinal reinforcing bar between the clamping piece and the drainage pipe, and also altitudinal reinforcing bar on the drainage pipe and clamping piece. Cross-sectional shape of the reinforcing bar may be triangular, rectangular or in any other shape. In addition, the clamping piece from the second representation or the present representation may simultaneously exist on a drainage pipe, which means having clamping pieces on both the inner and outer walls of the drainage pipe that penetrates the mounting slot. Cross-sectional shape of the drainage pipe may also be in various shapes, such as square, oval or trapezoidal. Nevertheless, when the cross-sectional shape of the drainage pipe changes, the shape of the pipe cap and connector must change accordingly.

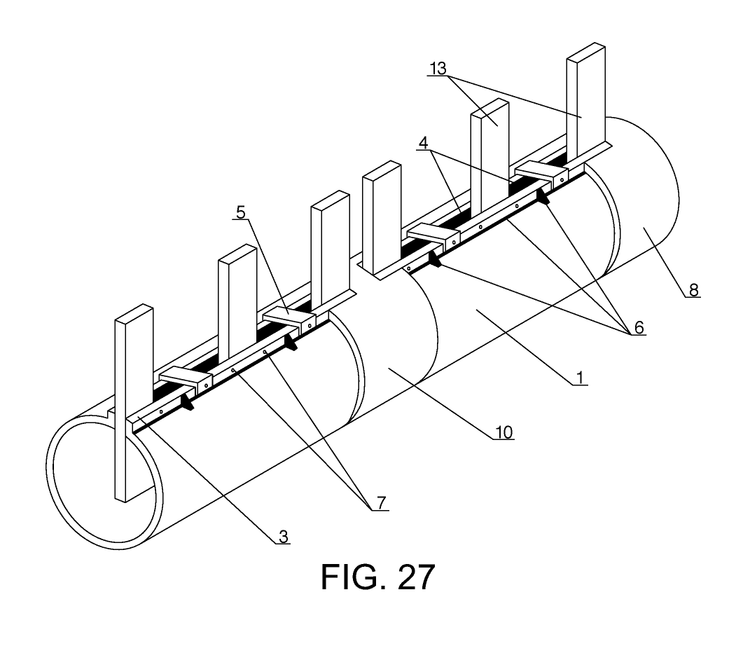

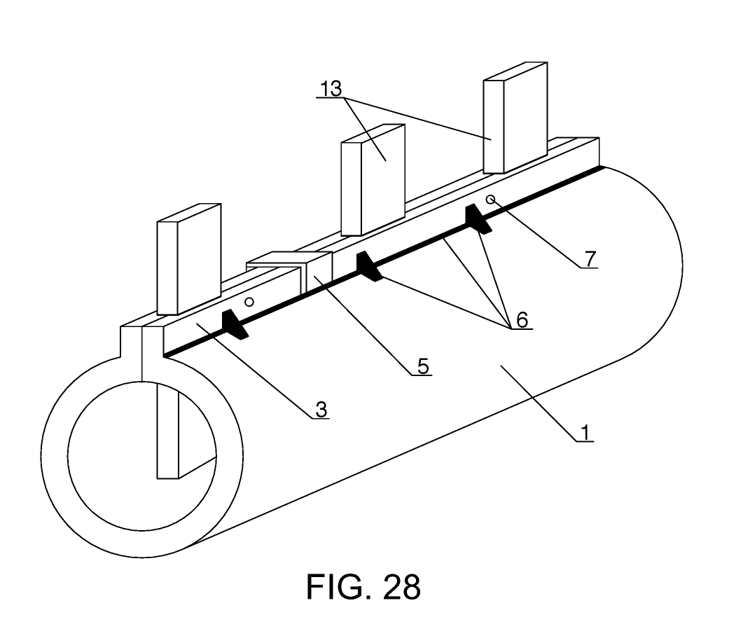

FIG. 27 is a fourth schematic representation of the implementation of the present embodiment. The difference between the present representation and first representation is the cross-sectional shape of the drainage pipe. Drainage pipe from the first representation has clamping piece on the inner wall the pipe body, wherein the present representation has clamping piece on the outer wall of the drainage pipe. Moreover, the present representation has a longitudinal reinforcing bar between the clamping piece and the drainage pipe, and also an altitudinal reinforcing bar on the drainage pipe and clamping piece. In addition, the present representation provided a fixation device for securing the two clamping pieces, and further stabilizing the capillary drainage belt/board. Such design utilizes threaded mounting hole and fixation device to significantly increase the stability of the capillary drainage belt/board.

Also note that the first representation of the present embodiment may provide fixation devices on the clamping pieces to secure the capillary drainage belt/board.

### Embodiment 6

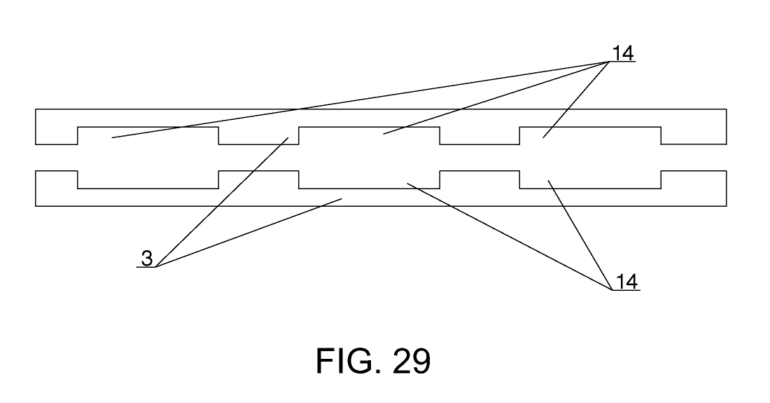

As shown in FIGS. 28 and 29, the difference between the present embodiment and embodiment 3 is an addition of groove 14 on the facing sides of the two clamping pieces. The present embodiment does not incorporate a gap sealing strip from embodiment 3, and provides several grooves along the gaps of the clamping pieces instead. When the capillary drainage belt/boards needs to be installed in intervals, the belt/boards may be installed at the groove and be secured by the two clamping pieces. Sections without the groove will naturally come together to form a tight seal, so no gap sealing strip will be needed. Screws may be used to secure the clamping pieces through the threaded mounting holes. “U” shaped fixation devices may also be utilized to secure the clamping pieces. Or, both the screws and fixation devices, or other devices may be used to secure the clamping pieces. Meanwhile, in order to strengthen the pipe body, reinforcing bars may be installed on the pipe body. In particular, the reinforcing bars may be placed longitudinally, attitudinally or in both directions between the clamping piece and the pipe body. Under practical applications, both the connector and the pipe cap may be used to secure the clamping pieces. In particular, secure the clamping pieces by applying pressure through the corresponding gap slots. In this case, fixation device and screws may be omitted.

In addition, note that the present invention not only applies to the capillary drainage belt/board, but also applies to any other belt or board-shaped drainage material and product.

The principal utilization of the present invention can be employed in various embodiments without departing from the scope of the invention. In addition, the present embodiments are meant to encompass any nonessential deviations from the principle utilization of the present invention, and are considered to be within the scope of this invention and are covered by the claims.

### DETAILED DESCRIPTION OF THE INVENTION

The purpose of the present utility model is to provide a type of drainage pipe and drainage system to fulfill the present request for a full-length coverage of the “capillary drainage belt/board,” which resolves the insufficiency from the conventional connection between the drainage pipe and the “capillary drainage belt/board.”

In order to fulfill the request, the present utility model establishes the following technical solutions: A type of drainage pipe, in which the pipe body contains a mounting slot for the installation of capillary drainage belt/board, and a fixation mechanism on the pipe body at the opening of the mounting slot for fixating the capillary drainage belt/board.

Also, said pipe body features one or more mounting slot, which extends longitudinally along the entire length of the pipe, for the installation of capillary drainage belt/board. The pipe body may also contain more than one mounting slot that extends longitudinally along the length of the pipe with spacing in-between each slot.

In addition, said fixation mechanism includes two clamping pieces connecting to the pipe body. The mounting slot has one clamping piece on each side of the slot.

Moreover, said clamping pieces may position on the outer surface of the pipe body, inside the pipe body, or extend from the outer surface into the inner space of the pipe body.

Furthermore, said clamping pieces and pipe body may be formed from injection moulding or integrally formed from synthetic resin or other materials, and may be removable.

As an option, said two clamping pieces are provided with a sealing strip for sealing the gap between the clamping pieces, and/or the two opposing sides of the two clamping pieces are provided with a groove.

As another option, said clamping pieces are further provided with a fixation device for reinforcing the stability between the capillary drainage belt/board and the clamping pieces.

In addition, said mounting slot is further provided with a reinforcing bar for reinforcing the strength of the pipe body. The clamping pieces or pipe body are also provided with threaded mounting holes for reinforcing the stability between the capillary drainage belt/board and the clamping pieces.

The drainage system comprising said drainage pipes having drainage pipe connected to one end of another drainage pipe and sealing with a pipe cap of another end. The pipe cap has one sealed end and one opened end. The opened end of the pipe cap is provided with one or more slot gap for securing the clamping pieces.

Furthermore, this utility model further comprises a connector for connecting two adjacent drainage pipes. The connector has a hollow cylindrical structure, with each end having one or more groove for securing the clamping pieces. The connector may also be a hollow columnar structure, with a groove extending along the entire length of the connector for securing the clamping pieces. The connector may also have annular separation rings projected on the inner wall.

The present utility model has the following advantages and beneficial effects in comparison with the prior art.

First, drainage pipes of the present utility model can be manufactured by assembly line or in batch injection moulding, which lowers costs, yields high efficiency, increases slotting accuracy and eliminates onsite manual slotting.

Second, the present utility model can be assembled from a factory assembly line, and requires only installation onsite. This lowers the labor costs and shortens the construction time significantly, thereby improving efficiency.

Third, both the clamping pieces and reinforcing bar of the present utility model have reinforcement effects, and help to resolve the conventional problem of weakening in pipe strength after having too many mounting slots on the pipe structure. The present invention not only prevents an overall weakening in pipe strength, but also effectively improves pressure resistance and tensile strength of the pipes.

Fourth, with the present utility model, the contact between the “capillary drainage belt/board” and the drainage pipe is tighter and more secure, which prevents the “capillary drainage belt/boards” from slipping or pulling out of the mounting slots.

Fifth, in contrast with the conventional spacing between each capillary drainage belt/board, the present utility model offers a continuous coverage of the capillary drainage belt/board along the entire length of the drainage pipe, thereby increasing the overall drainage area and draining efficiency.

Sixth, in contrast with limitations of the conventional slotting method, the present utility model offers a continuous mounting slot along the entire longitudinal length of the pipe, which allows flexible positioning and spacing adjustment of the capillary drainage belt/boards.

Seventh, continuous installation, equally spaced installation, overlapping of two sides installation, or reinforced double-sided installation of the capillary drainage belt/board can all be accomplished without conventional restrictions.

And last, the present utility model can substitute for the conventional “capillary drainage pipe,” and overcome the existing issues of a lack of water and soil separation from gravity, a lack of water induction from siphoning effect, lower pressure resistance and weaker tensile strength due to close spacing between the coupling connectors.

What is claimed is:

1. A drainage pipe comprising:
a pipe body having a mounting slot for an installation of a capillary drainage belt or a capillary drainage board; and
a fixation mechanism at the mounting slot on the pipe body for securing the capillary drainage belt or the capillary drainage board.

2. The drainage pipe of claim 1, wherein said pipe body comprises at least one mounting slot along an entire longitudinal length of the pipe body for installing the capillary drainage belt or the capillary drainage board.

3. The drainage pipe of claim 2, wherein the fixation mechanism comprises two clamping pieces connecting to the pipe body at opposite sides of the mounting slot.

4. The drainage pipe of claim 3, wherein the two clamping pieces are provided on an outer wall or an inner wall, or is extending from the outer wall into the inner wall of the pipe body.

5. The drainage pipe of claim 3, wherein the two clamping pieces and the pipe body are integrally formed or detachable.

6. The drainage pipe of claim 3, further comprising a gap sealing strip located between the two clamping pieces, or a groove at an inward-facing side of the two clamping pieces.

7. The drainage pipe of claim 3, further comprising a fixation device on the two clamping pieces for stabilizing the capillary drainage belt or the capillary drainage board.

8. The drainage pipe of claim 3, further comprising a reinforcing bar on the mounting slot for reinforcing a pipe body strength, and a threaded mounting hole on the two clamping piece or the pipe body for stabilizing the capillary drainage belt or the capillary drainage board and the two clamping pieces.

9. A drainage system comprising:
a drainage pipe that comprises a pipe body having a mounting slot for an installation of a capillary drainage belt or a capillary drainage board; and a fixation mechanism at the mounting slot on the pipe body for securing the capillary drainage belt or the capillary drainage board;
a pipe cap connected to a terminal end of the drainage pipe for sealing the terminal end, wherein the pipe cap has a sealed end and an open end; and
at least one slot gap at the open end of the pipe cap for securing a plurality of a clamping piece.

10. The drainage system of claim 9, further comprising a connector for connecting the drainage pipe to an adjacent drainage pipe and an annular separation ring projecting on a mid-inner wall, wherein the connector has a hollow cylindrical structure with at least one opening for fixation at each of two ends of the hollow cylindrical structure.

11. The drainage system of claim 9, further comprising a connector for connecting the drainage pipe to an adjacent drainage pipe and an annular separation ring projecting on a mid-inner wall, wherein the connector has a hollow cylindrical structure with at least one opening extending longitudinally along an entire length of the connector.
